(19) United States
(12) Patent Application Publication
(10) Pub. No.: US 2017/0171286 A1
(43) Pub. Date: Jun. 15, 2017

(54) METHODS AND DEVICES FOR VALIDATING A VIDEO CONNECTION OR OTHER TYPES OF COMMUNICATION SESSIONS OVER A COMPUTER NETWORK

(71) Applicant: VIDEODESK SA, Paris (FR)

(72) Inventors: Olivier Coste, New York, NY (US); Regis Duval, Paris (FR)

(21) Appl. No.: 14/970,370

(22) Filed: Dec. 15, 2015

(51) Int. Cl. H04L 29/08; H04L 29/06; H04L 12/26

(52) U.S. Cl. CPC H04L 67/02; H04L 43/0852; H04L 43/0894; H04L 65/403; H04L 65/1069; H04L 67/303

(57) ABSTRACT

A computer-implemented method comprises receiving a request from a computing device accessing a web page; responsive to receiving the request, testing an ability of the device to enter into a communication session; loading the web page; and prompting the user to participate in a first type of session if the testing reveals an ability for the device to enter into a session of the first type. The user may be prompted to participate in a second type of session if the testing reveals an ability for the device to enter into a session of the second type. The user may be prompted to participate in a third type of session if the testing reveals an ability for the device to enter into a session of the third type. A communication session of the first, second or third type may be selectively initiated upon the user selecting a prompted session.

### BACKGROUND

Embodiments are related to video, audio and text conferencing or communication sessions. The video conferencing sessions may be initiated and carried out using a web browser. However, these sessions may fail to start or may fail during the session, for a variety of reasons. Both in the consumer and enterprise markets, such failures may be costly in terms of lost sales, missed opportunities and frustrated participants.

### BRIEF DESCRIPTION OF THE DRAWINGS

FIG. 1 is a diagram of a system in which an embodiment may be practiced.

FIG. 2 is a flowchart and block diagram showing aspects of one embodiment.

FIG. 3 is a block diagram of a computing device configured to carry out a computer-implemented method according to one embodiment.

### DETAILED DESCRIPTION

According to one embodiment, virtual conferencing software allows individuals to participate in not only in online text chats, but also in live audio and video conversations directly on any website, without requiring the web-user to download additional software or to create or sign-in to a user account. Indeed, in the case of video chat for e-commerce, as is the case for the consumer market, a visitor to a website may be reluctant to download any plugin or application to enable the video chat functionality. To enable this functionality, a short script may be added to the merchant website, as disclosed in co-pending and commonly assigned U.S. patent application Ser. No. 14/261,127 filed on Apr. 24, 2014, which is incorporated herein by reference in its entirety. As a result, Internet shoppers or B2B users in the enterprise environment may use their web browser to connect with a live agent on a specific website and receive assistance at the click of a button. The availability of a live agent provides a pleasant, non-intrusive experience for web visitors. Customer can privately browse a website at their leisure with the peace of mind engendered by the knowledge they are but one step away from personal, live and immediate assistance from a knowledgeable sales or support agent.

Moreover, any viable conferencing solution, whether for the consumer or enterprise markets, should work with the visitor's existing software embedded in the visitor's browser and should work with the visitor's network, whose available bandwidth may be unstable, variable, unreliable and/or shared and with the visitor's hardware resources, which may not support real time, full duplex high-quality video conferencing. For example, fluctuations in bandwidth are common in shared environments such as, for example, WiFi in an office setting or public areas. Also, the visitors' computing devices may have a wide variety of configurations, not all of which support the preferred communication session modality. For example, the visitor's hardware configuration may not, in fact, support the envisaged video conferencing session. Indeed, the visitor's computer may lack a microphone and/or speakers. Also, the visitor's software configuration may not be up to the task, as it may have an outdated version of Flash, an old operating system or browser or may not implement. For example, WebRTC (Web Real-Time Communication) may or may not be available on the user's computing device. WebRTC is an API definition drafted by the World Wide Web Consortium (W3C) that supports browser-to-browser applications for voice calling, video chat, and P2P file sharing without the need of either internal or external plugins.

In other cases, the video communication session may fail because the visitor's network may be configured to block some audio or video protocols, for security reasons, due to the presence of a firewall, proxies, network address translation (NAT), unavailable ports or for other reasons altogether. Lack of User Datagram Protocol (UDP) connectivity may also be the reason why a communication session fails. Blocked protocols may include, for example, WebRTC Turn or Stun, Flash RTMFP (Real-Time Media Flow Protocol) or RTMP (Real Time Messaging Protocol) or the like. Another reason why a particular type of communication session may fail is that the visitor's local network may not have sufficient bandwidth to support audio or both audio and video or may have insufficient bandwidth from his or her Internet Service Provider (ISP). In these cases, attempting to initiate and maintain a video chat connection may generate more frustration than goodwill, as the anticipated video communication session devolves into a frustrating experience—with pixelated video and dropped frames and garbled sound, for example.

According to one embodiment, therefore, the visitor's hardware, software and network configuration may be tested before any invitation for the visitor to participate in a video communication session is generated and posted on the visitor's browser. According to one embodiment, such testing of hardware, software and network configuration may be carried out at or before each page load. In this manner, the invitation or prompt to participate in a video communication session is only posted to the user's browser when such a video communication session is likely to succeed; that is, when the visitor's hardware, software and network resources are deemed to be sufficient to support a successful video communication session. If the visitor's hardware, software and network resources are deemed to be insufficient to support a successful video communication session, the quality of the video and audio may be degraded or the anticipated video communication session may be replaced with an audio-only communication session or a text-only communication session and the visitor may only be prompted to initiate a communication session of a type that is likely to succeed. This, in effect, manages the user's expectations and subsequent experience during the communication session and leads to more successful and satisfying interaction between the visitor and the party with whom the visitor is chatting.

According to one embodiment, a small amount of code (including javascript code, for example) may be caused to run on the computing device accessing the web page, which code may be configured to provide the hardware and software configuration of the visitor's computing device, as the visitor loads the web page. The code may also be run at other times, to detect, for example, changed network conditions. Different code may be necessary for different browsers such as Internet Explorer, Edge, Firefox, Safari, Chrome and the like. For example, checking UDP connectivity may be carried out differently when Flash is available, as compared with cases in which HTML5 is present, such as is currently the case with the Firefox and Chrome browsers. According to one embodiment, the small amount of code may be loaded onto the visitor's browser in some cases and may not be loaded onto the visitor's browser in other cases. For HTML5 browsers such as Firefox and Chrome, such loading may not be required. According to one embodiment, it may be determined at page load whether the visitor's browser supports Flash. If not (as is the case with the Microsoft Edge browser, for example), it may be decided to not invite or prompt the user to engage in a video communication session.

To properly evaluate the visitor's network security and bandwidth, one embodiment envisages launching a real connection, which is more resource-intensive, as such must be carried out each time a visitor arrives at a website in which an embodiment is deployed. Such tests, according to one embodiment, may be light (not require the transfer of a lot of data) and quick, to enable a decision to be made in real-time whether to invite or prompt the visitor to initiate a video communication session or to, instead, prompt the visitor to initiate a comparatively less resource-intensive communication session, such as an audio-only or text communication session. If the decision is that the visitor's resources are likely sufficient to support a video communication session, the visitor may be invited or prompted to initiate such a video communication session. If, however, the decision is that the visitor's resources are likely insufficient to support a video communication session, such an invitation or prompt may not be made or the visitor may be invited or prompted to participate in a comparatively less resource-intensive type of interaction with the vendor or other service provider.

### Bandwidth Probe

One embodiment may utilize a software bandwidth probe to detect the latency and the bandwidth from the web server or communication session service provider to the visitor's is browser. After the visitor connects to the web server, a call to the bandwidth probe made initiate bandwidth detection. The web server or communication session service provider may thereafter send chunks of data to the visitor and wait for a return value from the visitor's browser. The bandwidth detection probe may return one or more values indicative of the available bandwidth between the web server or communication session service provider and the visitor. According to one embodiment, the size of the data chunks the server sends to the client, the rate at which the data is sent, and the amount of time the server waits between data chunks, may be freely selectable.

According to one embodiment, the bandwidth probe or tester function may be launched on an appropriate Flash server, and the result thereof may be stored locally. This result may be retrieved from local memory and, based therein, a determination may be made as to the level of service to present to the visitor. For example, depending upon the result of the bandwidth probe, a determination may be made to suggest a video communication session, a co-browsing session, an audio-only communication session or a text communication session.

So as to be largely transparent to the visitor, the duration of the bandwidth test or test should be, according to one embodiment, sufficiently short as to not noticeably affect the speed at which the webpage loads. This also means that the size of the packets sent to the visitor's browser should be small. For example, the size of the baseline data chunks used for the bandwidth detection may be about 8192 Bytes or 65536 bits. Other baseline sizes for the data chunks to be used in the bandwidth testing may be selected, as those of skill may recognize. The bandwidth test, according to one embodiment, may be iterative in nature. For example, three iterations may be carried out with such data chunks. For example, if the bandwidth test indicates that the visitor's browser does not acknowledge safe receipt of a single 65536 bit baseline data chunk within a predetermined period of time of, for example, 1 second, the capacity of the channel between the visitor and the webserver may be less than 65536 bits/sec., which is less than required for a co-browsing session, a video communication session or an audio communication session. In that case, the webserver or the server that enables and implements the chat functionality may offer only a text communication session or no communication session at all. This test may be carried out unbeknownst to the visitor and in a manner that ensures that whatever communication session option is offered, it should be initiated and be carried out successfully. If a first iteration using a baseline 65536 bit data chunk size is completed during the 1 second bandwidth test but a second iteration using the baseline data chunk size was not completed within the allotted time, the bandwidth of the channel may be assumed to be 200 Kbits/sec or less. This is sufficient for an audio communication session of acceptable quality, but not a video communication session. Therefore, an audio communication session may be offered, as may be a text communication session.

A second iteration may be carried out, with two data chunks, each having a baseline size of, for example, 65536 bits. If successful, the available bandwidth may be assumed to be at least 200 Kbits/sec. In this case, additional considerations may be taken into account in deciding what form of customer interaction should be offered. For example, if WebRTC is enabled, such as would be the case if the customer was using the Chrome or Firefox browsers, then a video communication session option may be provided to the customer. If only Flash is enabled, such as would be case if the customer was using the Internet Explorer or Safari browsers, then an audio-only or text only communication session or support session would be offered to the customer. According to one embodiment, when Flash is unavailable, only a text communication session may be proposed to the user.

According to one embodiment, if a third iteration is carried out successfully (that is, if three data chunks are sent and acknowledged), then an available bandwidth of 400 Kbits/sec may be assumed and a video communication session may be offered to the customer, irrespective of the browser used. According to one embodiment, such iterations are carried out within a limited and predetermined period of time. In one implementation, that limited and predetermined period of time is one second. Other time intervals may be used to gauge the bandwidth. However, such time interval should not significantly detract from the customer's experience. If the time interval is too long, many customers will give up and point their browsers somewhere else. Also, the size of the data chunks used for the bandwidth probe may be changed. For example, 16 Kbyte data chunks (organized as packets with appropriate headers and payload) may be used. If the size of the data chunk used is too large (e.g., 400 Kbytes or larger), then an appropriate number of such larger data chunks will not be able to be sent to gain a clear picture of the available bandwidth within the allotted period of time.

Therefore, according to one embodiment, a very limited number of small-sized data chunks (up to three data chunks or packets, in one embodiment) may be sent within the predetermined period of time and, depending upon how many of these packets are received and acknowledged by the customer's browser, a sufficiently clear picture of the available end-to-end bandwidth between the customer's browser and the chat (text, audio or video) provider may be extrapolated to allow an intelligent decision to be made, with respect to which form of customer interaction to offer the accessing browser: Text only, text and audio communication session or text, audio and video communication session. Other alternatives may also be offered such as, for example, remote control of the customer's desktop or other forms of co-browsing, depending upon the determined or estimated available bandwidth. As such, embodiments provide significant improvements, rooted in computer technology, in addressing the technological problems of providing users with the form of customer interaction best suited to their local computing and network resources and doing so in a manner that is transparent to the users.

It is to be understood that the end-to-end bandwidth includes the bandwidth of the customer's local network, the bandwidth the customer may have purchased from his or her Internet Service Provider (ISP), whether the path is P2P or server-relayed, among other considerations. It is also noted that the bandwidth may continuously vary depending upon usage patterns that may vary throughout the day and may vary seasonally. Accordingly, one embodiment continues to test the bandwidth during the call or communication session, to dynamically adapt to unstable bandwidth. In the case in which too many packets are dropped during a support or communication session, the customer may be preemptively invited to switch to an audio-only communication session or to a text session, as appropriate.

According to one embodiment, the application enabling the functionality shown and described herein may be configured to detect and monitor the bandwidth available between the customer's accessing computing device and the servers to which the application communicates. According to one embodiment, the quality (e.g., resolution, frame rate, etc.) of the video session may be reduced upon detection of dropped packets that are indicative of a poor quality communication channel or insufficient bandwidth to support the current video or audio quality. As a result, the communication session may be automatically downgraded to an audio-only session or text-only communication session as needed, if the bandwidth detected drops below predetermined static or dynamically determined thresholds. According to embodiments, the best possible video and audio quality may be ensured for every call by altering the video quality based on, for example, the device (e.g.: CPU, OS), network conditions (e.g.: bandwidth, latency, packet loss) and automatically selecting the best or appropriate communication protocol (such as WebRTC P2P, Flash RTMP and the like). Audio quality may be advantageously set to be at least equivalent to a standard cell phone quality of service. The bandwidth for frill duplex video chat may be capped at some predetermined maximum such as, for example, 600 kbps. Moreover, during video communication session, an occasional video freeze should be undetectable by the customer, or quickly resolved.

According to one embodiment, the testing, in the aggregate, may return an object that encapsulates values corresponding to the results of the testing of the user's computing device and network environment. For example, a data object “TestingResultsObject” may encapsulate, results of the bandwidth testing, the observed latency, the presence of an enabled microphone, the presence of an enabled webcam and a value representative of the presence or absence of UDP connectivity: TestingResultsObject {bw_value, latency, micro, webcam, is_udp}. Some of these values may be numeric, while others may be Booleans. For example, the result of testing may return object TestingResultsObject {bw_value: 23171, latency: 51, micro: 2, webcam: 1, is_udp: true}, indicating that the measured bandwidth was 23 Mbits/sec, the latency 51 milliseconds, 2 microphones were detected, one webcam was found and there was UDP connectivity detected. Such TestingResuitsObject may then be passed to a decision engine to select the appropriate form, if any, of communication session to offer to the customer visiting the website.

### Text Communication Session Fallback

According to one embodiment, when the network does not allow access to WebRTC servers and does not allow for Flash fallback, then only a text communication session option may be presented to the visitor—or no communication session at all. The network may not allow access to WebRTC servers due to, for example, a firewall that is present and is blocking the WebRTC signaling ports. The network may not allow to Flash fallbacks because, for example, the visitor's browser may not feature or support Flash. According to one embodiment, the text communication session option may be presented to the visitor when the service level also allows for text communication session (and not video communication session only) and the network does not support WebRTC servers and does not allow Flash fallbacks.

### Hardware Detection

According to one embodiment, the presence or absence of specific hardware such as, for example, a microphone, may be detected prior to offering to initiate a video communication session or an audio-only communication session with the visitor. When no microphone is detected, only a text communication session may be offered by, for example, displaying a text communication session service button or some other user interface device on the visitor's browser. In some cases, a deactivated microphone may be detected. In that case, unless the microphone can be re-activated, a text communication session-only session may be offered to the visitor. In other cases, a muted microphone may be present on the visitor's computing device. In that case, the muted microphone may be detected, even though it will not transduce the visitor's voice. In that case as well, a text communication session only option may be offered to the visitor. Alternatively, a message may be generated, to alert the visitor and give him or her the opportunity to unmute the muted microphone, so as to allow audio or full video communication session or a co-browsing+audio option.

According to one embodiment, the customer service representative may be notified when a customer has requested a communication session. If queuing is implemented, the customer service representative may be provided information detailing how many customers are waiting in queue for a communication session. Upon being so notified, the customer service representative, if immediately available, clicks a button to “accept” the communication session. The customer service representative may be provided with the customer's IP address and any other information that may be available, such as city/state, company name, and the like. The customer service representative may also, according to one embodiment, be provided with the metadata of one or more previous communication sessions including, for example, browser info, current page, referrer, IP address, geographic area. During the communication session, the customer service representative may share specific video and document files with the customer. The customer service representative and/or the customer may disconnect (end) the communication session at any time for any reason.

If the communication session is unexpectedly interrupted, the customer may be sent the option to immediately re-engage with the same customer service representative via video chat or the previously used communication mode (e.g., text chat, audio only or video). A message may be displayed to the customer if their previous customer service representative is otherwise occupied and the customer may be invited to wait or to initiate a communication session with another customer service representative. A Web-user Service and Support (CSS) may be provided, to create canned messaging/templates available for use by customer service representatives. A detailed record of each customer interaction may be kept and archived including, for example, transcripts, screen shots, co-browsing details, which videos and/or documents were pushed, duration of interaction, among other possible items of information. Accordingly, operational metrics report (including, for example, session transcripts, chat length, average wait time, agent utilization, number of sessions, CPE, AHT, speed to answer) may be generated and archived by customer service representative, vendor, and site. Such data may be exported to, for example, Excel for review and quality purposes. Other performance metrics, such as chats provided, chats initiated, chats connected, chats completed, chats converted, revenue per communication session, items per basket in session, contribution margin in session, among other possibilities, may be collected and stored for later retrieval and analysis. Indeed, according to one embodiment, session data (including, for example, text chat messages, information detailing the customer's hardware (webcam, microphone, etc.) and detailing the customer's software (operating system, browser, etc.) may be recorded in real-time and stored in a session record within a .csv (according to one implementation) file. Exports of the .csv file may then be delivered to the IT department of the vendor or other organization handling the vendor's back office.

The maximum response time for a customer service representative to respond to a request for a communication session from a customer may be set to a predetermined value such as, for example, 15 seconds, except for agreed to exclusions. Response time may be defined as the time elapsed after the customer initiating a communication session (by clicking a Live chat button, for example) until the customer can see and hear the customer service representative.

According to one embodiment, the functionality described herein may be provided as a software as a service (SaaS) architecture that operates in a cloud environment. Multi-level security and controls may be provided to ensure the confidentiality and safeguarding of customer information and ensure a controlled access to system functions and features. Access to predetermined areas and functionality of the application may be controlled, according to one embodiment, based on system function to be performed. For security purposes, the communication channel with the customer service representative may be secured (e.g., a secure socket layer (SSL) and encryption) to prevent interception thereof by interlopers. Alternatively, a Real Time Messaging Protocol (RTMP) may be used, such as RTMPE, which is an Adobe variant of the RTMP protocol that utilizes a 128-bit encrypted channel for data between client and the server. RTMPE does not use certificate management and is well suited for applications that do not require endpoint authentication and that require more performance and speed than is possible with SSL. To specify an encrypted channel, the RTMPE protocol may be utilized in the connection URI in the form, for example, nc.connect(“rtmpe://www.example.com/mediaapplication”). For voice and video media flows, for example, the Flash protocol may be implemented, enabling encryption with RTMPE, a Flash proprietary security solution using standard cryptography primitives, and RTMPs over a TLS/SSL connection protocols.

Text chats and internal communications may be protected via https encryption. Other protocols such as RTMPS (a protocol for enabling secure communications over TCP/IP) may be used. According to one embodiment, to specify an RTMPS connection, the RTMPS protocol may be used in the connect URI, and the following syntax may be employed: nc.connect(“rtmps://www.example.com/mediaapplication”). Data passed over RTMPS is protected by SSL guarantees. The RTMFP protocol, which uses 128-bit encryption, may also be used. Data passed over RTMFP is encrypted with the well-known block cipher encryption algorithm. The algorithm may be keyed using a well-known public-key-exchange algorithm, which prevents passive observation and provides perfect forward secrecy. Session nonces are provided and are tied to the key exchange, thereby enabling client and server authentication to be built on top of the exchanged values. To establish a peer-to-peer connection, a subscribing peer must know the peer ID of a publishing peer. These peer IDs are guaranteed to be unique for each instance of Flash Player. Peer IDs may be configured as 256 bit values created from a cryptographically random source. When an RTMFP peer connects to another RTMFP peer using a peer ID, the public-key-exchange algorithm is tied to the peer ID so that it is not possible to conduct a man-in-the-middle attack. To specify an RTMFP connection, the RTMFP protocol in the connect URI may be used with a format of, for example: nc.connect(“rtmfp://www.example.com/mediaapplication”).

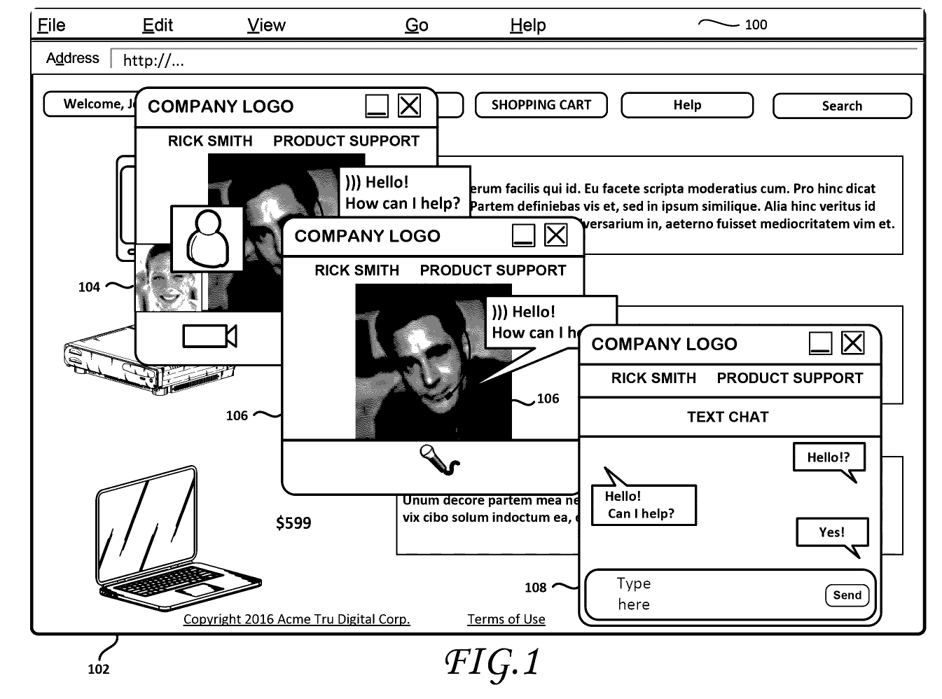

FIG. 1 shows aspects of one embodiment. As shown therein, a customer, John, has accessed a page 102 of a website. That is, John's computing device may have sent and a web server may have received, over a computer network, an (for example) http request for access to a page or a document 102. Responsive to this request, the web server and/or another server or servers may initiate testing, to determine the ability of the accessing computing device to enter into a communication session such as, for example, a video communication session, an audio communication session or a text communication session. This testing may be initiated at least as early as the initial access to the page and/or during the loading the page of the website on the accessing computing device. That is, before and/or while the web server is serving up the requested pages or documents, the web server or some other server or servers may carry out at least some of the hardware, software and/or bandwidth tests described herein.

According to one embodiment, carrying out such testing before any such communication session is requested by the customer or suggested by a script on the site ensures that the type communication session that is ultimately suggested is of a type that is likely to result in a satisfying user experience. For a video conferencing session, a satisfying communication session may be one in which the video is smooth, crisp and at least relatively free of dropped frames and skips. Likewise, a successful or satisfying audio communication session may be one in which the audio quality is at least as good as a mobile telephone or Skype® session. Similarly, a satisfying text session may be thought of as one that establishes and maintains a reliable text conversation between the customer and a customer service agent. According to one embodiment, depending upon the results of the software, hardware and bandwidth testing, a video communication session may be offered, as shown at 104, an audio communication session may be offered, as suggested at 106 or the customer may be invited to enter into a text-only communication session, as suggested at 108. According to one embodiment, if a video communication session 104 is offered, so may be an audio communication session 106 and a text communication session 108, as the resources needed for a video communication session 104 are likely sufficient to support an audio communication session 106 and a text communication session 108. Similarly, if the testing reveals adequate software, hardware and/or bandwidth resources to support an audio communication session 106, a text communication session 108 may also be offered.

Therefore, according to one embodiment, the user may be prompted, on the loaded page of the website, to participate in a first type of communication session (e.g., a video communication session 104) if the testing, carried out over the computer network, reveals that the user's computing device has the ability to enter into a communication session of this first type. Likewise, the user may be prompted, on the loaded page of the website, to participate in a second type of communication session (e.g., an audio communication session 106) if the testing reveals that the user's computing device has the ability to enter into a communication session of this second type. Similarly, the user may be prompted, on the loaded page of the website, to participate in a third type of communication session (e.g., a text communication session 108) if the testing reveals that the user's computing device has the ability to enter into a communication session of this third type. Depending upon the prompted type of communication session, a communication session of the first, second or third type may be initiated upon the user selecting a prompted communication session. It is to be understood that, according to one embodiment, should testing reveal that the user's computing device (and the network environment in which the user's computing device is operating) does not support a given type of communication sessions, such would not be offered to the user. According to one embodiment, such testing occurs at least partially during the loading of the page requested by the user, and in a manner that does not detract from the user's experience in navigating the welcome or the deeper-linked pages of the website.

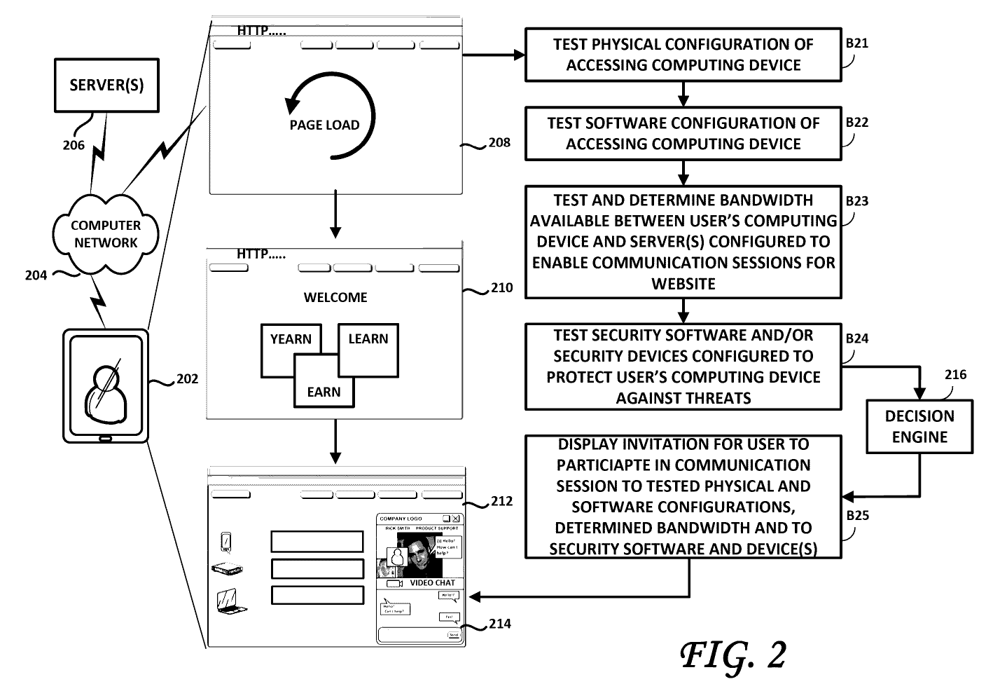

FIG. 2 is a flowchart and diagram that illustrates further aspects of one embodiment. As shown therein, the user may visit a webpage 208. Before the page loads, as the page loads and/or shortly thereafter, a number of tests may be carried out, to determine which form of communication session may be best suited to the user's computing device and the network environment in which the user's computing device is being used. For example, as shown at B21, the physical configuration of the accessing computing device may be tested. Such may include, for example, the presence of absence of a microphone or a video camera. As suggested at B22, the software configuration of the user's accessing computing device may also be determined including, for example, the operating system, presence of necessary drivers, Flash, HTML5 and/or other software components and communication protocols. As shown at B23, the testing may also include testing the bandwidth available between the user's computing device and the server or servers configured to enable the communication sessions for the website. These servers may be the web servers themselves or may include third party servers dedicated to enabling the communication sessions described herein for the website. As shown at B24, the security software and/or hardware (e.g., hardware and software firewalls) that protect the user's computing device against threats may also be tested, to determine whether a communication session (be it video, audio or text) is likely to be allowed. During these tests, a welcome page may have loaded, as shown at 210 in FIG. 2. Alternatively, the user may have accessed a deep-linked page directly, which may then be rendered, as shown at 212.

The results of the testing may be passed to a decision engine 216, to decide which type of communication session, if any, with which to prompt the user. As shown at B25, if the decision engine 216 determines that the testing in B21-B24 suggests that a communication session would likely be successful, an invitation to participate in a selected communication session may be displayed, as shown at 214. The communication session to which the user is invited to participate, according to one embodiment, may be selected based on the results of the testing in B21-B24. In FIG. 2, the testing in B21-B24 reveals that a video communication session would likely be successful, so the user may be prompted to participate in such, by causing an invitation to a video communication session to appear on the web page.

According to one embodiment, the testing may be carried out within a predetermined period of time. The predetermined period of time may be selected such that the user experience on the website is not noticeably affected. In one embodiment, the testing is carried out before the requested page of the website is fully loaded.

According to one embodiment, the structures and functionalities disclosed herein may be distributed across one or more servers. For example, such server(s) may be configured to comprise or support a Flash communications engine, a customer and customer service representative communication management engine(s), a co-browsing and screen-sharing engine(s), a development and software storage server, one or more media library servers, one or more WebRTC communication engines, one or more storage servers for communication session data and one or more servers and engines for front and back office functionalities. Other implementations are possible, as those of skill in this art may recognize. Some or all of these functionalities may be served by a same server or the functionalities may be distributed across geographically or co-located separate servers.

In one embodiment, the bandwidth available may be further monitored while the user is on the website and even while the user is engaging in a communication session. For example, if the available bandwidth degrades during a video communication session, an invitation to switch to an audio or text communication session may be generated. Or, should be available bandwidth increase when the user is engaging in a text or audio session, the user may be prompted to upgrade the communication session to a video session or to a co-browsing session. The monitoring of hardware, software and network resources may be on-going, and may dynamically adapt to the available resources such as, for example, hardware, software and network resources.

The invitation to participate in a given type of communication session may be affected, according to one embodiment, by more than the results of the hardware, software and network testing described herein. Indeed, an invitation for the user to participate in a communication session of a given type may be predicated upon the availability of a customer service agent that is ready to participate in such a communication session within an acceptable period of time. For example, even if testing reveals that a video and/or co-browsing session is possible with the customer, the prompting to participate in such a session may be predicated upon the availability of an agent slot to initiate the session. The decision to display an invitation to participate in a communication session of a given type may be affected by other factors as well. A fallback message may be displayed for the user if no communication session is ready to be initiated. Alternatively, no message regarding communication sessions may be displayed at all.

One embodiment is a website, configured according to one embodiment. Such a website may be accessed over a computer network, as shown at, for example, FIG. 1. The website, according to one embodiment, may be deployed by one or more physical computer servers and may be configured to:
test, or cause to be tested, a physical configuration of the user's computing device to determine the computing device's ability to support communication sessions of different types;
test, or cause to be tested, a software configuration of the user's computing device to determine the computing device's ability to support communication sessions of different types;
test, or cause to be tested, and determining a bandwidth available between the user's computing device and one or more servers configured to enable communication sessions of different types; and
test, or cause to be tested, security software and devices configured to protect the computing device of the user against threats to determine whether communication sessions with the user's computing device will be allowed.

Responsive to results of the testing, the website may be configured to cause an invitation to be displayed, on the accessed page of the website, for the user to participate in a communication session that is appropriate to the physical configuration of the user's computing device, to the software configuration of the user's computing device, to the determined bandwidth between the user's computing device and the one or more servers and to the security software and devices protecting the computing device of the user.

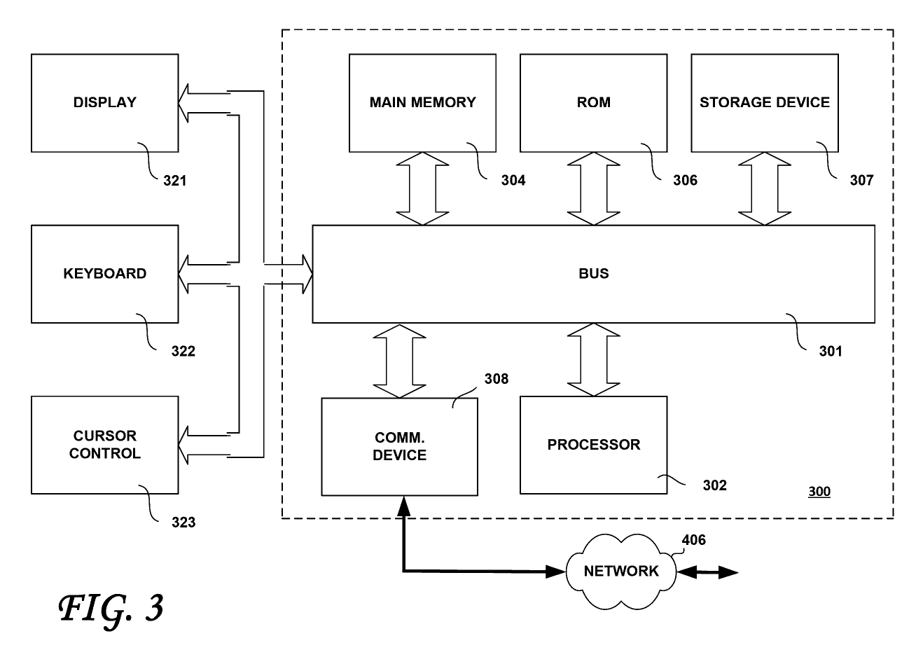

FIG. 3 is a block diagram of a computing device configured to carry out a method according to one embodiment. FIG. 3 may also be thought of as showing a server, such as shown at 206 in FIG. 2, although not all components shown may be present in each. FIG. 3 illustrates a block diagram of a computing device or server upon or with which embodiments may be implemented. The computing device or server may include a bus 301 or other communication mechanism for communicating information, and one or more processors 302 coupled with bus 301 for processing information and executing instructions. Computing device or server may further comprise a random access memory (RAM) or other dynamic storage device 304 (referred to as main memory), coupled to bus 301 for storing information and instructions to be executed by processor(s) 302. Main memory 304 also may be used for storing temporary variables or other intermediate information during execution of instructions by processor 302. The computing device or server also may include a read only memory (ROM) and/or other static storage device 306 coupled to bus 301 for storing static information and instructions for processor(s) 302. A data storage device 307, such as a magnetic disk or solid state data storage device may be coupled to bus 301 for storing information and instructions. The computing device or server may also be coupled via the bus 301 to a display device 321 for displaying information to a computer user. An alphanumeric input device 322, including alphanumeric and other keys, may be coupled to bus 301 for communicating information and command selections to processor(s) 302. Another type of user input device is cursor control 323, such as a mouse, a trackball, touch functionality or cursor direction keys for communicating direction information and command selections to processor(s) 302 and for controlling cursor movement on display 321. The computing device or server may be coupled, via a communication device (e.g., modem, Network Interface Card (NIC)) to computer network 406 and/or to other devices or services such as databases or other servers configured to implement an embodiment.

Embodiments are related to the use of computing device or server to test computing devices for suitability to various types of communication sessions and to offer one or more communication sessions of appropriate types according to the results of the testing. According to one embodiment, the methods, devices and systems described herein may be provided by one or more computing devices or server in response to processor(s) 302 executing sequences of instructions contained in memory 304. Such instructions may be read into memory 304 from another computer-readable medium, such as data storage device 307. Execution of the sequences of instructions contained in memory 304 causes processor(s) 302 to perform the steps and have the functionality described herein. in alternative embodiments, hard-wired circuitry may be used in place of or in combination with software instructions to implement the described embodiments. Thus, embodiments are not limited to any specific combination of hardware circuitry and software. Indeed, it should be understood by those skilled in the art that any suitable computer system may implement the functionality described herein. The computing devices may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory or other non-transitory medium external to the microprocessor, or integrated with the microprocessor. In another embodiment, the instructions may be stored on a disk and read into a volatile semiconductor memory before execution by the microprocessor.

One embodiment is a physical, non-transitory machine-readable medium (a data carrier, mass storage device, etc.) having data stored thereon representing sequences of instructions which, when executed by a computing device, causes the computing device carry out the functionality shown and described relative to FIG. 1-2.

While certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A computer-implemented method, comprising:
receiving, over a computer network, a request from a computing device of a user accessing a page of a website;
responsive to receiving the request, testing an ability of the computing device to enter into a communication session;
loading the page of the website:
prompting, on the loaded page of the website, the user to participate in a first type of communication session if the testing reveals an ability for the computing device to enter into a communication session of the first type;
prompting, on the loaded page of the website, the user to participate in a second type of communication session if the testing reveals an ability for the computing device to enter into a communication session of the second type;
prompting, on the loaded page of the website, the user to participate in a third type of communication session if the testing reveals an ability for the computing device to enter into a communication session of the third type; and
selectively initiating a communication session of the first, second or third type upon the user selecting a prompted communication session.

2. The computer-implemented method of claim 1, wherein the first type of communication session includes a text communication session, the second type of communication session includes an audio communication session and the third type of communication session includes a video communication session.

3. The computer-implemented method of claim 1, wherein testing includes testing for a presence of at least one of a microphone and a camera.

4. The computer-implemented method of claim 1, wherein testing includes testing a bandwidth between the computing device of the user and a provider of the communication sessions of the first, second and third types.

5. The computer-implemented method of claim 1, wherein testing includes testing a latency between the computing device of the user and a provider of the communication sessions of the first, second and third types.

6. The computer-implemented method of claim 1, wherein testing is carried out within a predetermined period of time.

7. The computer-implemented method of claim 1, wherein testing is carried out before the page of the website is fully loaded.

8. The computer-implemented method of claim 1, wherein testing includes testing for a presence of one or more pieces of software and one or more software communication protocols.

9. The computer-implemented method of claim 1, wherein testing comprises sending a plurality of data packets of a predetermined size to the computing device of the user over the computer network within a predetermined period of time.

10. The computer-implemented method of claim further comprising re-testing the ability of the computing device during or after participation of the user in a communication session of the first, second or third types and returning to prompting depending upon the results of the re-testing.

11. The computer-implemented method of claim 1, further comprising populating a data object with results of the testing and passing the populated data object to a decision engine to decide which type of communication session to prompt the user.

12. A computer-implemented method of claim, comprising:
receiving, over a computer network, a request from a computing device of a user accessing a page of a website;
responsive to receiving the request, accessing the computing device and
testing a physical configuration of the user's computing device to determine the computing device's ability to support communication sessions of different types;
testing a software configuration of the user's computing device to determine the computing device's ability to support communication sessions of different types;
testing and determining a bandwidth available between the user's computing device and one or more servers configured to enable communication sessions of different types;
testing security software and devices configured to protect the computing device of the user against threats to determine whether communication sessions with the user's computing device will be allowed; and
responsive to results of the testing, displaying an invitation, on the accessed page of the website, for the user to participate in a communication session that is appropriate to the physical configuration of the user's computing device, to the software configuration of the user's computing device, to the determined bandwidth between the user's computing device and the one or more servers and to the security software and devices protecting the computing device of the user.

13. The computer-implemented method of claim 12, wherein testing is carried out upon loading the accessed page of the website.

14. The computer-implemented method of claim 12, wherein testing is again carried out after loading the accessed page of the website.

15. The computer-implemented method of claim 12, wherein the communication sessions of different types include a text communication session, an audio communication session, a video communication session and a co-browsing session.

16. The computer-implemented method of claim 12, wherein testing is carried out for each user accessing the website, whether or not the user desires to enter into a communication session at the website.

17. The computer-implemented method of claim 12, wherein testing includes testing for a presence of at least one of a microphone and a camera.

18. The computer-implemented method of claim wherein testing includes testing a latency between the computing device of the user and a provider of the communication sessions.

19. The computer-implemented method of claim 1, wherein testing is carried out within a predetermined period of time.

20. The computer-implemented method of claim 1, wherein testing is at least initiated carried out before the page of the website is fully loaded.

21. The computer-implemented method of claim 1, wherein testing includes testing for a presence of one or more pieces of software and one or more software communication protocols.

22. The computer-implemented method of claim 1, wherein testing the available bandwidth comprises sending a plurality of data packets of a predetermined size to the computing device of the user over the computer network within a predetermined period of time.

23. The computer-implemented method of claim 1, further comprising re-testing during or after participation of the user in a communication session and returning to displaying the invitation depending upon the results of the re-testing.

24. The computer-implemented method of claim 1, further comprising populating a data object with results of the testing and passing the populated data object to a decision engine to decide which communication session to invite the user to participate.

25. A website accessed over a computer network, configured to:
test a physical configuration of the user's computing device to determine the computing device's ability to support communication sessions of different types;
test a software configuration of the user's computing device to determine the computing device's ability to support communication sessions of different types;
test and determining a bandwidth available between the user's computing device and one or more servers configured to enable communication sessions of different types; and
test security software and devices configured to protect the computing device of the user against threats to determine whether communication sessions with the user's computing device will be allowed,
wherein the website is configured to, responsive to results of the testing, display an invitation, on the accessed page of the website, for the user to participate in a communication session that is appropriate to the physical configuration of the user's computing device, to the software configuration of the user's computing device, to the determined bandwidth between the user's computing device and the one or more servers and to the security software and devices protecting the computing device of the user.
